(19) United States
(12) Patent Application Publication
(10) Pub. No.: US 2025/0353550 A1
(43) Pub. Date: Nov. 20, 2025

(54) FRONT STRUCTURE OF VEHICLE

(71) Applicant: MAZDA MOTOR CORPORATION, Hiroshima (JP)

(72) Inventors: Hayato TAKEUCHI, Aki-gun (JP); Yui KUROKI, Aki-gun (JP); Tomohiro SHIMONO, Aki-gun (JP)

(73) Assignee: MAZDA MOTOR CORPORATION, Hiroshima (JP)

(21) Appl. No.: 19/081,848

(22) Filed: Mar. 17, 2025

(30) Foreign Application Priority Data
May 14, 2024 (JP) 2024-078837

(51) Int. Cl. B62D 21/15; B62D 21/02

(52) U.S. Cl. CPC B62D 21/155; B62D 21/02

(57) ABSTRACT

A front structure of a vehicle comprises a pair of right-and-left front side frames extending in a longitudinal direction and having a closed-cross section perpendicular to an extension direction thereof, respectively, and a cross member extending in a vehicle width direction between the pair of right-and-left front side frames, wherein each of the front side frames comprises an inner wall portion which is positioned on an inward side, in the vehicle width direction, thereof, the inner wall portion has a recess portion which is configured such that a front edge of the inner wall portion partially retreats rearward, and both-side portions, in the vehicle width direction, of the cross member fit into said respective recess portions of the inner wall portions from a forward side and are fixed to the inner wall portions of the front side frames.

### BACKGROUND OF THE INVENTION

The present invention relates to a front structure of a vehicle.

Japanese Patent Laid-Open Publication No. 2018-199407 discloses a vehicle front structure which comprises a pair of right-and-left front side members extending in a longitudinal direction, a front cross member extending between the pair of right-and-left front side members, and a pair of right-and-left joining members provided are respective front end portions of the pair of right-and-left front side members. In this vehicle front structure, each of the pair of right-and-left joining members includes a cylindrical insertion portion protruding inward, in a vehicle width direction, thereof. Both-side end portions of the front cross member are inserted into the right-and-left insertion potions for connection therebetween.

A so-called pole frontal-collision is known as one example of a vehicle's collision manner. In this pole frontal-collision, a pole-shaped obstacle, such as a utility (telephone) pole, hits against a central part, in the vehicle width direction, of the vehicle. A collision load is applied rearward to the front cross member in the pole frontal-collision. In this case, since the collision load is applied to the joining portion of the front cross member to the front side frame as a shearing load, so that there is a concern that the joining portion may get broken. Consequently, the front cross member may be detached from the front side frame, therefore the collision-load absorption performance of the front cross member may deteriorate.

### SUMMARY OF THE INVENTION

An object of the present invention is to provide a front structure of a vehicle which can effectively absorb the collision load in the pole frontal-collision of the vehicle.

The present invention is a front structure of a vehicle, comprising a pair of right-and-left front side frames extending in a longitudinal direction and having a closed-cross section perpendicular to an extension direction thereof, respectively, and a cross member extending in a vehicle width direction between the pair of right-and-left front side frames, wherein each of the front side frames comprises an inner wall portion which is positioned on an inward side, in the vehicle width direction, thereof, the inner wall portion has a recess portion which is configured such that a front edge of the inner wall portion partially retreats rearward, and both-side portions, in the vehicle width direction, of the cross member fit into the respective recess portions of the inner wall portions from a forward side and are fixed to the inner wall portions of the front side frames.

According to the present invention, the both-side portions of the cross member fit into the respective recess portions of the inner wall portions of the pair of right-and-left front side frames from the forward side and are fixed to the inner wall portions of the front side frames. Consequently, since the collision load which is applied to the cross member due to the pole frontal-collision of the vehicle or the like is supported at the recess portions in an axial direction of the front side frame, it can be suppressed that this collision load is applied to the fixation portions of the cross member to the front side frames as the shearing load.

Thereby, the both-side portions of the cross member are suppressed from being detached from the pair of right-and-left front side frames in the pole frontal-collision of the vehicle. Therefore, the cross member is deformed such that it has a U-shaped rearward-protrusion shape in a plan view, so that the both front side frames are easily curved inward, in the vehicle width direction, thereof by a shortened distance between the both-side portions of the cross member. Accordingly, the collision-load absorption performance in the pole frontal-collision of the vehicle can be improved by the cross member and the pair of right-and-left front side frames.

According to the present invention, the collision load can be effectively absorbed in the pole frontal-collision.

The present invention will become apparent from the following description which refers to the accompanying drawings.

### BRIEF DESCRIPTION OF THE DRAWINGS

FIG. 1 is a plan view of a front structure of a vehicle according to an embodiment of the present invention.

FIG. 2 is a side view of the front structure of the vehicle of FIG. 1.

FIG. 3 is a perspective view of a front portion of a front side frame, when viewed from an oblique forward side.

FIG. 4 is a perspective view of a first cross member, when viewed from an oblique rearward side.

FIG. 5 is a perspective view of a joining portion of the first cross member to the front side frame, when viewed from the oblique rearward side.

FIG. 6 is a plan view schematically showing a deformation manner of the front structure of the vehicle in a pole frontal-collision.

FIG. 7 is a perspective view of a front portion of a front side frame according to a modification, when viewed from an oblique forward side.

### DETAILED DESCRIPTION OF THE INVENTION

Hereafter, a front structure of a vehicle according to an embodiment of the present invention will be described referring to the accompanying drawings. The following description is mealy about the exemplified embodiment, and therefore the present invention is not be limited in its applications or uses by those.

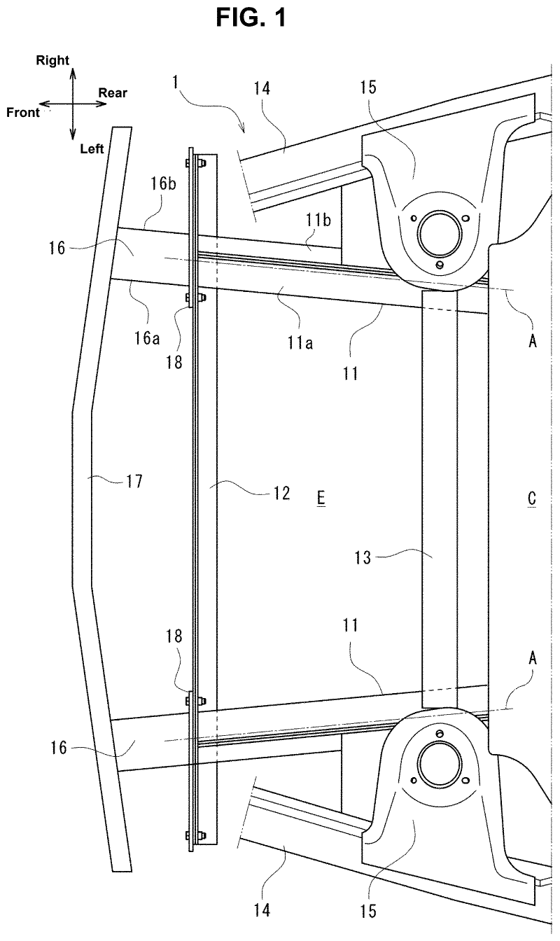

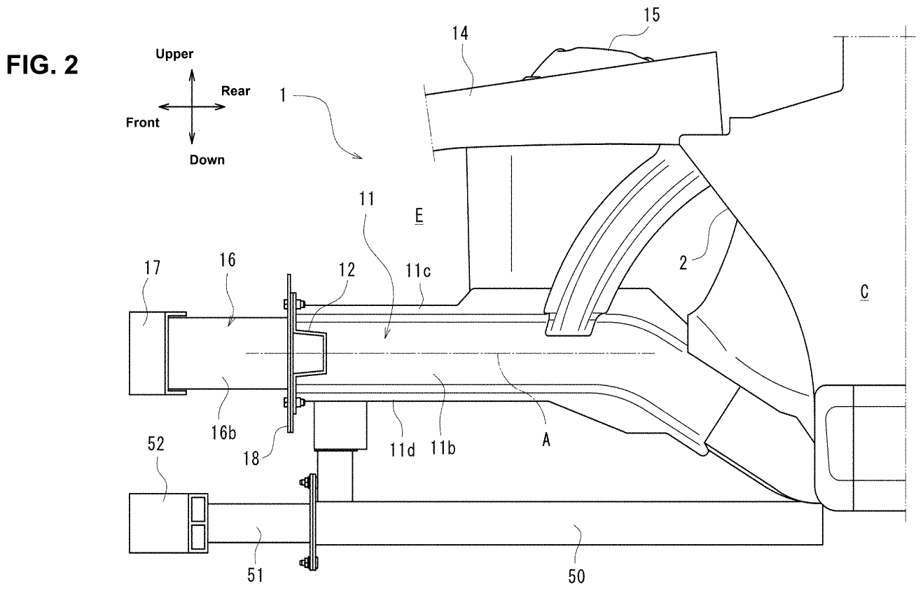

FIG. 1 is a plan view of a front structure 1 of the vehicle according to the present embodiment. FIG. 2 is a side view of the front structure 1 of the vehicle of FIG. 1. The front structure 1 of the vehicle of the present embodiment is the structure of an automobile or the like. Hereafter, there are some cases where a longitudinal direction, a width direction, and a vertical direction relative to the vehicle provided with the front structure 1 of the vehicle will be referred to as the “longitudinal direction,” the “width direction,” and the “vertical direction,” respectively. Further, there are some cases where a center-line side of the vehicle in the width direction is referred to as the inward side, in the vehicle width direction, of the vehicle and an opposite side to a center line of the vehicle, in the width direction, of the vehicle is referred to as the outward side, in the vehicle width direction, of the vehicle. The vehicle width direction matches a lateral direction of the vehicle.

As shown in FIG. 1, the front structure 1 of the vehicle comprises a dash panel 2 (see FIG. 2) partitioning an engine room E from a cabin C in the longitudinal direction, a pair of right-and-left front side frames 11 extending from the dash panel 2 in an axial direction A which is inclined obliquely forward-and-outward, in the vehicle width direction, thereof at right-and-left both-side portions of the engine room E, and a first cross member 12 and a second cross member 13 which extend in the vehicle width direction between the right-and-left front side frames 11. The first cross member 12 is positioned at a front end portion of the front side frames 11. The second cross member 13 is positioned in back of the first cross member 12.

The front structure 1 of the vehicle further comprises a pair of right-and-left apron reinforcements 14 which extend forward from the dash panel 2 on the outward side, in the vehicle width direction, and above the pair of right-and-left front side frames 11. A suspension hosing 15 is provided between each of the front side frames 11 and each of the apron reinforcements 14. A longitudinal position of the second cross member 13 substantially matches that of the suspension housing 15.

The front structure 1 of the vehicle further comprises a pair of right-and-left crash cans 16 extending in the longitudinal direction in front of the first cross member 12 at their respective lateral positions corresponding to the right-and-left front side frames 11 and a bumper reinforcement 17 interconnecting respective front end portions of the right-and-left crash cans 16 in the vehicle width direction. The crash can 16 constitutes an impact absorbing member to absorb the collision load through its axial compressive deformation in a vehicle frontal collision or the like.

The crash can 16 extends in parallel to the axial direction A of the corresponding front side frame 11. More specifically, the crash can 16 is arranged such that its inside face 16a positioned on the inward side, in the vehicle width direction, thereof is substantially positioned at an forward-extension area of an inner wall portion 11a of the corresponding front side frame 11 and also its outside face 16b positioned on the outward side, in the vehicle width direction, thereof is substantially positioned at a forward-extension area of an outer wall portion 11b of the corresponding front side frame 11.

The crash can 16 is fixed to a front end portion of the first cross member 12 at its rear end portion via a set plate 18 by fastening, for example, and its front end portion is fixed to the bumper reinforcement 17 by welding, for example.

As shown in FIG. 2, the front structure 1 of the vehicle further comprises a subframe 50 which is located below the front side frames 11. The subframe 50 is suspended from the front side frames 11 at its front-half part, and its rear-half part is fixed to a vehicle-body frame. In the present embodiment, the subframe 50 is a suspension cross member to suspend a front suspension and the like. The subframe 50 is further provided with a pair of right-and-left sub crash cans 51 extending forward at its front end portion and a sub bumper reinforcement 52 interconnecting respective front end portions of the sub crash cans 51 in the vehicle width direction. The sub crash can 51 constitutes the impact absorbing member like the crash can 16 as well.

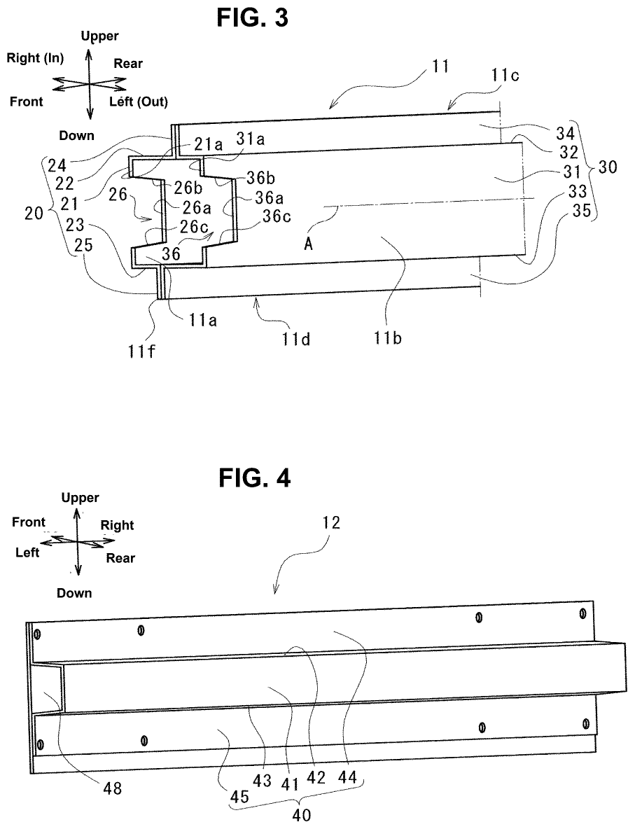

FIG. 3 shows the front side frame 11 positioned on the left alone, which is a perspective view of a surrounding area of the front end portion of the frame 11, when viewed from a front-left side. As shown in FIG. 3, the front side frame 11 comprises a side frame inner 20 positioned on the inward side, in the vehicle width direction, thereof and a side frame outer 30 positioned on the outward side, in the vehicle width direction, thereof.

The side frame inner 20 of the present embodiment is formed to have a hat-shaped cross section perpendicular to the extension direction A which is open outward, which is made by steel-plate pressing. Specifically, the side frame inner 20 comprises an inner side-wall portion 21 extending in the vertical direction, an inner upper-wall portion 22 extending outward from an upper edge of the inner side-wall portion 21, an inner lower-wall portion 23 extending outward from a lower edge of the inner side-wall portion 21, an inner upper-flange portion 24 extending upward from an outer edge of the inner upper-wall portion 22, and an inner lower-flange portion 25 extending downward from an outer edge of the inner lower-wall portion 23.

The inner side-wall portion 21 has an inner recess portion 26 which is configured such that a front edge 21a, in the longitudinal direction, of the inner side-wall portion 21 partially retreats rearward in a side view. The inner recess portion 26 is formed by partially cutting-out a front end portion of the inner side-wall portion 21 such that this cutout portion is of a trapezoidal shape which is open to the forward side. The inner recess portion 26 is located at a roughly central position, in the vertical direction, of the inner side-wall portion 21.

The inner recess portion 26 is partitioned by an inner recess-portion bottom edge 26a extending in the vertical direction, an inner recess-portion upper edge 26b connecting an upper end portion of the inner recess-portion bottom edge 26a and the front edge 21a, and an inner recess-portion lower edge 26c connecting a lower end portion of the inner recess-portion bottom edge 26a and front edge 21a. The inner recess-portion upper edge 26b extends obliquely rearward-and-downward. The inner recess-portion lower edge 26c extends obliquely rearward-and-upward.

The side frame outer 30 of the present embodiment is formed to have a hat-shaped cross section perpendicular to the extension direction A which is open inward, which is made by steel-plate pressing. Specifically, the side frame outer 30 comprises an outer side-wall portion 31 extending in the vertical direction, an outer upper-wall portion 32 extending inward from an upper edge of the outer side-wall portion 31, an outer lower-wall portion 33 extending inward from a lower edge of the outer side-wall portion 31, an outer upper-flange portion 34 extending upward from an inner edge of the outer upper-wall portion 32, and an outer lower-flange portion 35 extending downward from an inner edge of the outer lower-wall portion 33.

The outer side-wall portion 31 has an outer recess portion 36 which is configured such that a front edge 31a, in the longitudinal direction, of the outer side-wall portion 31 partially retreats rearward in the side view. The outer recess portion 36 is formed by partially cutting-out a front end portion of the outer side-wall portion 31 such that this cutout portion is of the trapezoidal shape which is open to the forward side. The outer recess portion 36 is located at a roughly central position, in the vertical direction, of the outer side-wall portion 31.

The outer recess portion 36 is partitioned by an outer recess-portion bottom edge 36a extending in the vertical direction, an outer recess-portion upper edge 36b connecting an upper end portion of the outer recess-portion bottom edge 36a and the front edge 31a, and an outer recess-portion lower edge 36c connecting a lower end portion of the outer recess-portion bottom edge 36a and front edge 31a. The outer recess-portion upper edge 36b extends obliquely rearward-and-downward. The outer recess-portion lower edge 36c extends obliquely rearward-and-upward.

The front side frame 11 is configured to have a closed-cross section perpendicular to the axial direction A by joining the side frame inner 20 and the side frame outer 30. That is, the inner upper-flange portion 24 and the outer upper-flange portion 34 are joined together by spot welding or the like, and also the inner lower-flange portion 25 and the outer lower-flange portion 35 are joined together by spot welding or the like.

The inner wall portion 11a positioned on the inward side at the front side frame 11 is constituted by the inner side-wall portion 21. The outer wall portion 11b positioned on the outward side at the front side frame 11 is constituted by the outer side-wall portion 31. An upper flange portion 11c extending upward of the front side frame 11 is constituted by the inner upper-flange portion 24 and the outer upper-flange portion 34 which are joined together. A lower flange portion 11d extending downward of the front side frame 11 is constituted by the inner lower-flange portion 25 and the outer lower-flange portion 35 which are joined together.

The front side frame 11 is configured to have a flat front-end face 11f. That is, respective front-end faces of the side frame inner 20 and the side frame outer 30 are positioned such that they form the same flat face. In the present embodiment, the front end face 11f of the front side frame 11 is located on a plane which is parallel to the extension direction of the first cross member 12 and the vertical direction (i.e., on the plane perpendicular to the longitudinal direction).

The inner recess portion 26 and the outer recess portion 36 are formed in the same shape when viewed in the extension direction of the first cross member 12. Since the first cross member 12 extends in the vehicle width direction, the bottom edges 26a, 36a, the upper edges 26b, 36b, and the lower edges 26c, 36c of the inner recess portion 26 and the outer recess portion 36 overlap each other in the vehicle side view.

FIG. 4 is a perspective view of the first cross member 12, when viewed from a rear left side. As shown in FIG. 4, the first cross member 12 comprises a first cross body portion 40 positioned rearward and a first cross front-wall portion 48 positioned forward. The first cross front-wall portion 48 extends on a plane parallel to the vehicle width direction and the vertical direction.

The first cross body portion 34 of the present embodiment is provided to have a hat-shaped cross section perpendicular to the extension direction (vehicle width direction) which is open forward, which is made by steel-plate pressing. Specifically, the first cross body portion 40 comprises a cross rear-wall portion 41 extending in the vertical direction, a cross upper-wall portion 42 extending forward from an upper edge of the cross rear-wall portion 41, a cross lower-wall portion 43 extending forward from a lower edge of the cross rear-wall portion 41, a cross upper-flange portion 44 extending upward from a front edge of the cross upper-wall portion 42, and a cross lower-flange portion 45 extending downward from a front edge of the cross lower-wall portion 43. The shape of the cross section perpendicular to the extension direction of the first cross body portion 40 is uniform over its extension direction.

The cross upper-wall portion 42 extends obliquely rearward-and-downward, is parallel to the inner recess-portion upper edge 26b and the outer recess-portion upper edge 36b, and has the same length as these edges 26b, 36b in the axial direction A. The cross lower-wall portion 43 extends obliquely rearward-and-upward, is parallel to the inner recess-portion lower edge 26c and the outer recess-portion lower edge 36c, and has the same length as these edges 26c, 36c in the axial direction A. An upper end of the cross upper-flange portion 44 is located at the same level, in the vertical direction, as an upper end of the first cross front-wall portion 48. A lower end of the cross lower-flange portion 45 is located above a lower end of the first cross front-wall portion 48.

The first cross member 12 is configured to have a closed-cross section perpendicular to the axial direction by joining the first cross body portion 40 and the first cross front-wall portion 48. That is, the cross upper-flange portion 44 and the cross lower-flange portion 45 of the first cross body portion 40 are joined to the first cross front-wall portion 48 from behind by spot welding or the like. This closed-cross section is uniform over the extension direction. The cross section of the first cross member 12 has a trapezoidal shape, which is configured such that its vertical height decreases gradually toward the rear side.

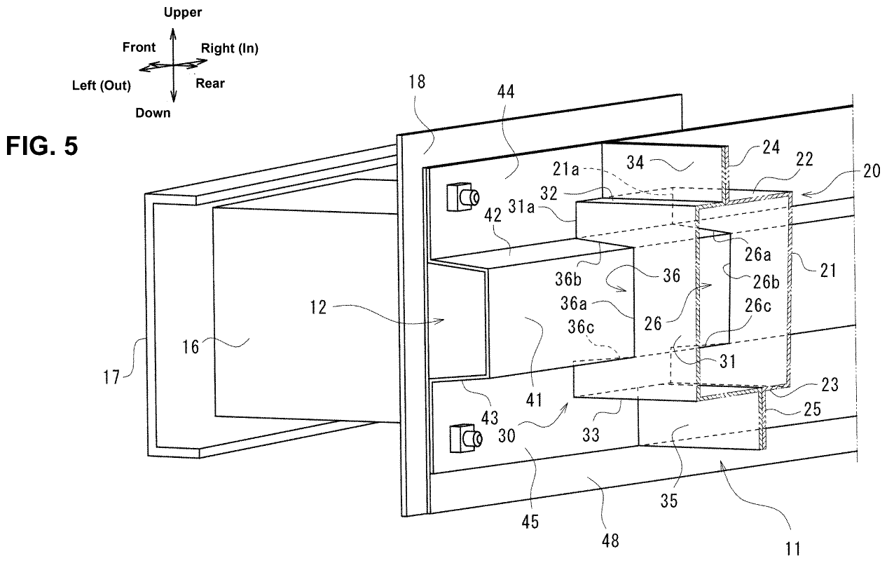

FIG. 5 is an enlarged perspective view around a joining portion of the left-side front side frame 11 to the first cross member 12, when viewed from a rear left side. As shown in FIG. 5, the trapezoidal-shaped cross section of the first cross member 12 is configured to be complementary to the inner recess portion 26 and the outer recess portion 36 of the front side frame 11, and this cross-section portion fits into the inner recess portion 26 and the outer recess portion 36 from the forward side.

In the present embodiment, the first cross member 12 penetrates the front side frame 11 in the vehicle width direction. That is, the first cross member 12 extends outward, in the vehicle width direction, beyond the outer side-wall portion 32 of the front side frame 11. Further, in the present embodiment, the first cross member 12 extends outward, in the vehicle width direction, beyond an outside face 16b of the crash can 16.

Accordingly, the cross rear-wall portion 41 is parallel to the inner recess-portion bottom edge 26a and the outer recess-portion bottom edge 36a, has the same length as these edges 26a, 36a in the extension direction, and contact these edges 26a, 36a. Likewise, the cross upper-wall portion 42 is parallel to the inner recess-portion upper edge 26b and the outer recess-portion upper edge 36b, has the same length as these edges 26b, 36b in the extension direction, and contact these edges 26b, 36b.

A part of the front side frame 11 which excludes the inner recess portion 26 and the outer recess portion 36, that is-the front end face 11f contacts the cross upper-flange portion 44 and the cross lower-flange portion 45 from behind.

An upper end of the upper flange portion 11c of the front side frame 11 is located at the same level as an upper end of the cross upper-flange portion 44 in the vertical direction. A lower end of the lower flange portion 11d of the front side frame 11 is located at the same level as a lower end of the cross lower-flange portion 45 in the vertical direction.

The first cross member 12 fits into the inner recess portion 26 and the outer recess portion 36 of the front side frame 11 from the forward side and is fixed to these recess portions 26, 36. Specifically, the respective edges 26a-26c of the inner recess portion 26 and the respective edges 36a-36c of the outer recess portion 36 are respectively joined to the cross rear-wall portion 41, the cross upper-wall portion 42, and the cross lower-wall portion 43 of the first cross member 12 by line welding.

Further, at the first cross member 12, the cross upper-flange portion 44 and the cross lower-flange portion 45 are fixed to the front end face 11f of the front side frame 11 by line welding.

The crash can 16 is fixedly fastened to the first cross member 12 from the forward side. Specifically, the crash can 16 is fixedly fastened to the cross upper-flange portion 44, the cross lower-flange portion 45, and the first cross front-wall portion 48 of the first cross member 12 via the set plate 18. Accordingly, the cross upper-flange portion 44, the cross lower-flange portion 45, and the first cross front-wall portion 48 of the first cross member 12 serve as a set plate to fix the crash can 16.

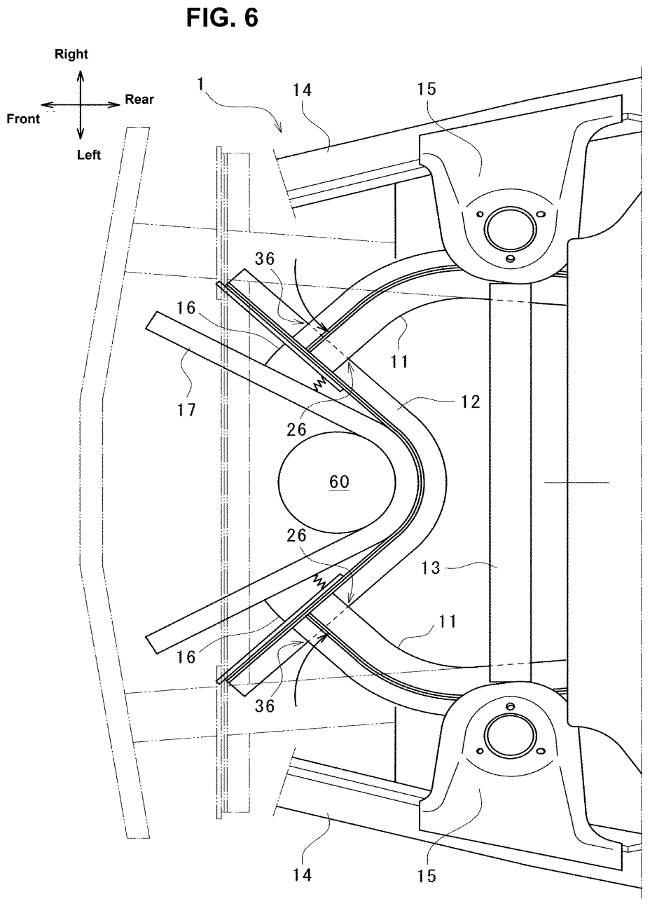

FIG. 6 is a plan view schematically showing a deformation manner of the front structure 1 of the vehicle in the pole frontal-collision of the vehicle. As shown in FIG. 6, when a pole-shaped obstacle 60 hits against a central part, in the vehicle width direction, of the front structure 1 of the vehicle, the first cross member 12 is deformed, together with the bumper reinforcement 17 and the sub bumper reinforcement 52 (see FIG. 2), such that it has a U-shaped rearward-protrusion shape with its both-side portions moving inward in the plan view.

Herein, the both-side portions, in the vehicle width direction, of the first cross member 12 are fixed such that they fit into the respective inner recess portions 26 and the respective outer recess portions 36 which are formed at the respective front end portions of the pair of right-and-left front side frames 11. Consequently, since the collision load applied to the first cross member 12 is received in the axial direction A of the front side frames 11, the shearing load applied to the fixation portions of the first cross member 12 to the pair of right-and-left front side frames 11 is reduced. Thereby, the first cross member 12 is suppressed from being detached from the front side frames 11, and the proper fixation is maintained.

Accordingly, the right-and-left front side frames 11 are drawn inward due to the U-shaped deformation of the first cross member 12, so that the front side frames 11 are deformed inward in a curved manner. Thus, the collision load applied to the central part, in the vehicle width direction, of the vehicle is absorbed not only by the U-shaped deformation of the bumper reinforcement 17, the sub bumper reinforcement 52, and the first cross member 12 but also by the inward bending of the pair of right-and-left front side frames 11. Consequently, the absorption performance of the collision load in the pole frontal-collision by means of the front structure 1 can be improved.

The front structure 1 of the vehicle of the present invention performs the following effects.

(1) The front structure 1 of the vehicle comprises a pair of right-and-left front side frames 11 extending in the longitudinal direction and having the closed-cross section perpendicular to the extension direction, respectively, and the first cross member 12 extending in the vehicle width direction between the pair of right-and-left front side frames 11, wherein each of the front side frames 11 comprises the inner wall portion 11a which is positioned on the inward side, in the vehicle width direction, thereof, the inner wall portion 11a has the inner recess portion 26 which is configured such that the front edge 21a of the inner wall portion 11a partially retreats rearward, and the both-side portions, in the vehicle width direction, of the first cross member 12 fit into the respective recess portions 26 of the inner walls 11a from the forward side and are fixed to the inner wall portions 26 of the front side frames 11.

In the present specification, the description of “the front side frame 11 extends in the longitudinal direction” includes not only a case where it extends in parallel to the vehicle longitudinal direction but also another case where it extends mostly along the vehicle longitudinal direction with a slight inclination angle to the vehicle longitudinal direction.

According to this structure, the both-side portions of the first cross member 12 fit into the respective recess portions 26 of the inner wall portions 11a of the pair of right-and-left front side frames 11 from the forward side and are fixed to the inner wall portions 11a of the front side frames 11. Consequently, since the collision load which is applied to the first cross member 12 due to the pole frontal-collision of the vehicle or the like is supported at the recess portions 26 in the axial direction A of the front side frame 11, the shearing load applied to the fixation portions of the first cross member 12 to the pair of right-and-left front side frames 11 is reduced.

Thereby, the both-side portions of the first cross member 12 are suppressed from being detached from the pair of right-and-left front side frames 11 in the pole frontal-collision of the vehicle. Therefore, the first cross member 12 is deformed such that it has the U-shaped rearward-protrusion shape in the plan view, so that the both front side frames 11 are easily curved inward, in the vehicle width direction, thereof by the shortened distance between the both-side portions of the first cross member 12. Accordingly, the collision-load absorption performance in the pole frontal-collision of the vehicle can be improved by the first cross member 12 and the pair of right-and-left front side frames 11.

(2) Each of the front side frames 11 comprises the outer wall portion 11b which is positioned on the outward side, in the vehicle width direction, thereof, the outer wall portion 11b has the recess portion 36 which is configured such that the front edge 31a of the outer wall portion 11b partially retreats rearward, and the both-side portions, in the vehicle width direction, of the first cross member 12 fit into the respective recess portions 36 of the outer wall portions 11b from the forward side and are fixed to the outer wall portions 11b of the front side frames 11.

According to this structure, the both-side portions of the first cross member 12 fit into the outer recess portions 36 of the outer wall portions 11b and are fixed to the outer wall portions 11b, in addition to the inner wall portions 11a. Consequently, since the collision load applied due to the pole frontal-collision of the vehicle is properly supported at the front side frame 11 in the axial direction A, the both-side portions of the first cross member 12 are further suppressed from being detached from the pair of right-and-left front side frames 11. Accordingly, the collision-load absorption performance in the pole frontal-collision of the vehicle can be further improved.

(3) The first cross member 12 has the cross section perpendicular to the extension direction (the vehicle width direction) which is of the uniform shape over the width direction thereof and comprises the cross rear-wall portion 41 extending in the vertical direction, the cross upper-wall portion 42 extending forward from the upper edge of the cross-rear wall portion 41, and the cross lower-wall portion 43 extending forward from the lower edge of the cross rear-wall portion 41, the inner recess portion 26 comprises the inner recess-portion bottom edge 26a extending in the vertical direction, the inner recess-portion upper edge 26b extending forward from the upper end portion of the inner recess-portion bottom edge 26a, and the inner recess-portion lower edge 26c extending forward from the lower end portion of the inner recess-portion bottom edge 26a. Further, the outer recess portion 36 comprises the outer recess-portion bottom edge 36a extending in the vertical direction, the outer recess-portion upper edge 36b extending forward from the upper end portion of the outer recess-portion bottom edge 36a, and the outer recess-portion lower edge 36c extending forward from the lower end portion of the outer recess-portion bottom edge 36a. Also, the cross rear-wall portion 41 is fixed to the inner recess-portion bottom edge 26a from the forward side, the cross upper-wall portion 42 is fixed to the inner recess-portion upper edge 26b from the lower side, and the cross lower-wall portion 43 is fixed to the inner recess-portion lower edge 26c from the upper side, and/or the cross rear-wall portion 41 is fixed to the outer recess-portion bottom edge 36a from the forward side, the cross upper-wall portion 42 is fixed to the outer recess-portion upper edge 36b from the lower side, and the cross lower-wall portion 43 is fixed to the outer recess-portion lower edge 36c from the upper side.

According to this structure, since the first cross member 12 is supported by the inner recess portions 26 and/or the outer recess portions 36 in the vertical direction and from the rearward side, the both-side portions of the first cross member 12 are suppressed from being detached from the pair of right-and-left front side frames 11 more.

(4) The first cross member 12 comprises the first cross body portion 40 which includes the cross rear-wall portion 41, the cross upper-wall portion 42, the cross lower-wall portion 43, the cross upper-flange portion 44 extending upward from the front edge of the cross upper-wall portion 42, and the cross lower-flange portion 45 extending downward from the front edge of the cross lower-wall portion 43 and the first cross front-wall portion 48 which extends vertically between the cross upper-flange portion 44 and the cross lower-flange portion 45 and is fixed to the first cross body portion 40 from the forward side.

According to this structure, since the first cross member 12 is formed by the first cross body portion 40 and the first cross front-wall portion 48 so as to have the closed-cross section, the rigidity of the first cross member 12 can be improved easily.

(5) The cross rear-wall portion 41 is fixed to the inner recess-portion bottom edge 26a and/or the outer recess-portion bottom edge 36a by the line welding, the cross upper-wall portion 42 is fixed to the inner recess-portion upper edge 26b and/or the outer recess-portion upper edge 36b by the line welding, and the cross lower-wall portion 43 is fixed to the inner recess-portion lower edge 26c and/or the outer recess-portion lower edge 36c by the line welding.

According to this structure, since the both-side portions of the first cross member 12 are firmly fixed to the inner recess portions 26 and/or the outer recess portions 36 by the line welding at their three sides, the both-side portions of the first cross member 12 are further suppressed from being detached from the pair of right-and-left front side frames 11.

(6) The both-side portions of the first cross member 12 protrude outward, in the vehicle width direction, from the pair of right-and-left front side frames 11.

According to this structure, even in a case where the collision load is applied to an outward side, in the vehicle width direction, of the front side frames 11, the collision load can be absorbed easily by a portion of the first cross member 12 which protrudes outward, in the vehicle width direction, beyond the front side frames 11.

(7) The front structure 1 further comprises a pair of right-and-left crash cans 16 which are provided at the respective front sides of the pair of right-and-left front side frames 11 via the first cross member 12 and extend forward from the first cross member 12.

According to this structure, the collision load applied to the crash cans 16 can be transmitted, in the longitudinal direction, to the both-side portions of the first cross member 12 which are positioned just behind the crash cans 16. Since the both-side portions of the first cross member 12 are supported by the inner recess portions 26 and/or the outer recess portions 36 of the front side frames 11 in the axial direction A, the frontal-collision load is transmitted to the front side frames 11 efficiently and absorbed by the front side frame 11 effectively.

(8) The both-side portions of the first cross member 12 protrude outward, in the vehicle width direction, from the pair of right-and-left crash cans 16.

According to this structure, even in a case where the collision load is applied to an outward side, in the vehicle width direction, of the crash cans 16, the collision load can be absorbed easily by a portion of the first cross member 12 which protrudes outward, in the vehicle width direction, beyond the crash cans 16.

(9) The first cross member 12 has the cross section perpendicular to the extension direction (the vehicle width direction) which is of the uniform shape over its width direction and comprises the first cross front-wall portion 48 extending in the vertical direction and the first cross body portion 40 which is joined to the first cross front-wall portion 48 from the rearward side and forms the closed-cross section together with the first cross front-wall portion 48, and the crash can 16 is fixed to the first cross front-wall portion 48.

According to this structure, since the first cross front-wall portion 48 serves as the set plate to fix the rear end portion of the crash can 16, no other particular plate is necessary.

(10) The pair of right-and-left front side frames 11 are configured such that the respective front end faces 11f are fixed to the cross upper-flange portions 44 and the cross lower flange portions 45 from the rearward side.

According to this structure, the first cross member 12 is supported at the front end faces 11f of the front side frames 11 in the axial direction in addition to the inner recess portions 26 and/or the outer recess portions 36. Thereby, since the support rigidity of the first cross member 12 by means of the front side frames 11 increases, the collision load transmitted to the fixation portions of the first cross member 12 to the front side frames 11 in the pole frontal-collision can be dispersed to the inner recess portions 26 and/or the outer recess portions 36 and the front end faces 11f of the front side frames 11. Accordingly, the first cross member 12 is suppressed from being detached from the front side frames 11 more properly.

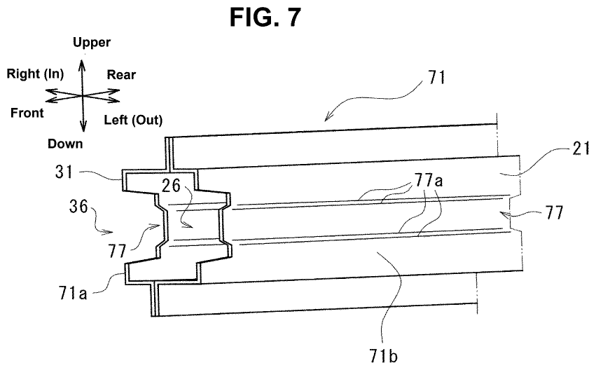

FIG. 7 is a perspective view showing a front side frame 71 alone according to a modification, which corresponds to FIG. 3. The front side frame 71 is different from the front side frame 11 of the above-described embodiment in a structure in which a groove portion 77 is provided at an inner wall portion 71a and an outer wall portion 71b.

The groove portion 77 is configured to be recessed from the inner wall portion 71 and the outer wall portion 71b in the vehicle width direction, and extends rearward from the respective recess-portion bottom edges 26a, 36a of the inner recess portion 26 and the outer recess portion 36. Bending ridgelines 77a which partition the groove portion 77 extend rearward from the respective recess-portion bottom edges 26a, 36a. The bending ridgelines 77a increase the rigidity of the front side frame 71 along the axial direction A of the inner wall portion 71a and the outer wall portion 71b, and also increase its bending rigidity along the vehicle width direction. Further, the inner recess portion 26 and the outer recess portion 36 are firmly supported from the rearward side by the high-rigidity bending ridgelines 77a.

Thus, according to the front side frame 71, the absorption performance for the collision load applied in the axial direction A in a so-called small overlap collision of the vehicle, for example, can be improved, and also the absorption performance for the collision load which is applied when the front side frame 71 is curved inward in the pole frontal-collision of the vehicle can be improved.

While the groove portion 77 extends rearward from the recess-portion bottom edges 26a, 36a in the above-described modification, the bending ridgelines 77a may be configured to extend rearward from the recess-portion upper edges 26b, 36b and/or the recess-portion lower edges 26c, 36c. That is, the groove portion 77 may be configured such that the bending ridgelines 77a connect to the edges of the inner recess portion 26 and/or the outer recess portion 36 in order to increase the support rigidity of the inner recess portion 26 and/or the outer recess portion 36.

While an example in which the recess-shaped groove portion 77 is formed at the inner wall portion 71a and the outer wall portion 71b is described in the above-described modification, a protrusion portion (not illustrated) which protrudes in the vehicle width direction and extends rearward from the inner recess portion 26 and/or the outer recess portion 36 may be provided additionally or alternatively. This protrusion portion can increase the support rigidity of the inner recess portion 26 and/or the outer recess portion 36 as well.

The front structure 1 of the vehicle according to the present invention is not limited to the above-described embodiment, and any modifications are applicable.

While the inner recess portion 26 and the outer recess portion 36 of the trapezoidal shape in the above-described embodiment, any shape, such as triangle, rectangular, polygonal, or semicircular shape, is applied as long as the first cross member 12 fits into these recess portions 26, 36. Herein, it is preferable that the vertical dimension (size) of the inner recess portion 26 and the outer recess portion 36 decrease toward the rearward side so that the longitudinal load can be received at both the upper-and-lower edges of the respective recess portions in order to increase the support rigidity, in the longitudinal direction, of the first cross member 12.

While both of the inner recess portion 26 and the outer recess portion 36 are provided at the front side frame 11 in the above-described embodiment, either one of those may be provided.

Further, the inner recess portion 26 and the outer recess portion 36 may have different shapes from each other as long as the cross section of the first cross member 12 is complementary to the inner recess portion 26 and the outer recess portion 36 of the front side frame 11. For example, in a case where the first cross member 12 has different cross-section shapes at respective fitting positions of the inner recess portion 26 and the outer recess portion 36, the shapes of the inner recess portion 26 and the outer recess portion 36 are different from each other.

Moreover, the inner recess portion 26 and the outer recess portion 36 may be located at any vertical position which is different from the center of each of the inner wall portion 11a and the outer wall portion 11b in the above-described embodiment. Also, these portions 26, 36 may be configured to be open at the upper side or the lower side. However, it is preferable that these portions 26, 36 be formed within a vertical scope of the inner wall portion 11a and the outer wall portion 11b, not being open at the upper side or the lower side, in order to support the first cross member 12 in the vertical direction.

The front side frame 11 and/or the first cross member 12 may be made of an aluminum extruded member, for example, not of the steel member.

The first cross member 12 may be joined to the front side frame 11 by not only the line welding but also any other means, such as spot welding, fastening, or adhesion.

While the fixation structure according to the present invention has been exemplified as an example where the both-side portions of the first cross member 12 are fixed to the front side frame 11, the present invention is not limited to this. It is applicable to the subframe 50 similarly. For example, the fixation structure of the present invention may be applied to a case (not illustrated) where a pair of right-and-left front side frames extending in the longitudinal direction at both-side portions of the subframe 50 and a first sub cross member extending in the vehicle width direction between the pair of right-and-left front side frames at a front end portion of the subframe 50 are fixed together. In this case, the collision load in the pole frontal collision of the vehicle can be properly absorbed at the subframe 50.

### ADDITIONAL NOTES

The front structure of the vehicle according to the present invention includes the following aspects.

### First Aspect

The front structure of the vehicle, comprising a pair of right-and-left front side frames extending in the longitudinal direction and having the closed-cross section perpendicular to the extension direction thereof, respectively, and the cross member extending in the vehicle width direction between the pair of right-and-left front side frames, wherein each of the front side frames comprises the inner wall portion which is positioned on the inward side, in the vehicle width direction, thereof, the inner wall portion has the recess portion which is configured such that the front edge of the inner wall portion partially retreats rearward, and the both-side portions, in the vehicle width direction, of the cross member fit into the respective recess portions of the inner wall portions from the forward side and are fixed to the inner wall portions of the front side frames.

### Second Aspect

The front structure of the vehicle of the first aspect, wherein each of the front side frames comprises the outer wall portion which is positioned on the outward side, in the vehicle width direction, thereof, the outer wall portion has the other recess portion which is configured such that the front edge of the outer wall portion partially retreats rearward, and the both-side portions, in the vehicle width direction, of the cross member fit into the respective other recess portions of the outer wall portions from the forward side and are fixed to the outer wall portions of the front side frames.

### Third Aspect

The front structure of the vehicle of the first or second aspects, wherein the cross member has the cross section perpendicular to the extension direction thereof which is of the uniform shape over the width direction thereof and comprises the cross rear-wall portion extending in the vertical direction, the cross upper-wall portion extending forward from the upper edge of the cross-rear wall portion, and the cross lower-wall portion extending forward from the lower edge of the cross rear-wall portion, the recess portion comprises the recess-portion bottom edge extending in the vertical direction, the recess-portion upper edge extending forward from the upper end portion of the recess-portion bottom edge, and the recess-portion lower edge extending forward from the lower end portion of the recess-portion bottom edge, the cross rear-wall portion is fixed to the recess-portion bottom edge from the forward side, the cross upper-wall portion is fixed to the recess-portion upper edge from the lower side, and the cross lower-wall portion is fixed to the recess-portion lower edge from the upper side.

### Fourth Aspect

The front structure of the vehicle of the third aspect, wherein the cross member comprises the cross body portion which includes the cross rear-wall portion, the cross upper-wall portion, the cross lower-wall portion, the cross upper-flange portion extending upward from the front edge of the cross upper-wall portion, and the cross lower-flange portion extending downward from the front edge of the cross lower-wall portion and the cross front-wall portion which extends vertically between the cross upper-flange portion and the cross lower-flange portion and is fixed to the cross body portion from the forward side.

### Fifth Aspect

The front structure of the vehicle of the third aspect, wherein the cross rear-wall portion is fixed to the recess-portion bottom edge by the line welding, the cross upper-wall portion is fixed to the recess-portion upper edge by line welding, and the cross lower-wall portion is fixed to the recess-portion lower edge by the line welding.

### Sixth Aspect

The front structure of the vehicle of the first or second aspects, wherein the both-side portions of the cross member protrude outward, in the vehicle width direction, from the pair of right-and-left front side frames.

### Seventh Aspect

The front structure of the vehicle of the first or second aspects, further comprising a pair of right-and-left impact absorbing members which are provided at the respective front sides of the pair of right-and-left front side frames via the cross member and extend forward from the cross member.

### Eighth Aspect

The front structure of the vehicle of the seventh aspect, wherein the both-side portions of the cross member protrude outward, in the vehicle width direction, from the pair of right-and-left impact absorbing members.

### Ninth Aspect

The front structure of the vehicle of the seventh aspect, wherein the cross member has the cross section perpendicular to the extension direction thereof which is of the uniform shape over the width direction thereof and comprises the cross front-wall portion extending in the vertical direction and the cross body portion which is joined to the cross front-wall portion from the rearward side and forms the closed-cross section together with the cross front-wall portion, and the impact absorbing member is fixed to the cross front-wall portion.

### Tenth Aspect

The front structure of the vehicle of the fourth aspect, wherein the pair of right-and-left front side frames are configured such that the respective front end faces thereof are fixed to the cross upper-flange portions and the cross lower-flange portions from the rearward side.

### Eleventh Aspect

The front structure of the vehicle of the first or second aspects, wherein each of the pair of right-and-left front side frames has the side wall portion where the recess portion is formed, and the groove portion which is recessed in the vehicle width direction and extends rearward from the recess portion or the protrusion portion which protrudes in the vehicle width direction and extends rearward from the recess portion are formed at the side wall portion.

### Twelfth Aspect

The front structure of the vehicle of the first or sixth aspects, wherein the pair of right-and-left front side frames extend obliquely forward-and-outward, in the vehicle width direction, thereof.

### Thirteenth Aspect

The front structure of the vehicle of the seventh aspect, wherein the impact absorbing member extends in parallel to the axial direction of the front side frame.

What is claimed is:

1. A front structure of a vehicle, comprising:
a pair of right-and-left front side frames extending in a longitudinal direction and having a closed-cross section perpendicular to an extension direction thereof, respectively; and
a cross member extending in a vehicle width direction between the pair of right-and-left front side frames,
wherein each of said front side frames comprises an inner wall portion which is positioned on an inward side, in the vehicle width direction, thereof, said inner wall portion has a recess portion which is configured such that a front edge of the inner wall portion partially retreats rearward, and both-side portions, in the vehicle width direction, of said cross member fit into said respective recess portions of the inner wall portions from a forward side and are fixed to the inner wall portions of the front side frames.

2. The front structure of the vehicle of claim 1, wherein each of said front side frames comprises an outer wall portion which is positioned on an outward side, in the vehicle width direction, thereof, said outer wall portion has another recess portion which is configured such that a front edge of the outer wall portion partially retreats rearward, and the both-side portions, in the vehicle width direction, of said cross member fit into said respective other recess portions of the outer wall portions from the forward side and are fixed to the outer wall portions of the front side frames.

3. The front structure of the vehicle of claim 1, wherein said cross member has a cross section perpendicular to an extension direction thereof which is of a uniform shape over a width direction thereof and comprises a cross rear-wall portion extending in a vertical direction, a cross upper-wall portion extending forward from an upper edge of said cross rear-wall portion, and a cross lower-wall portion extending forward from a lower edge of said cross rear-wall portion, said recess portion comprises a recess-portion bottom edge extending in the vertical direction, a recess-portion upper edge extending forward from an upper end portion of said recess-portion bottom edge, and a recess-portion lower edge extending forward from a lower end portion of said recess-portion bottom edge, said cross rear-wall portion is fixed to said recess-portion bottom edge from the forward side, said cross upper-wall portion is fixed to said recess-portion upper edge from a lower side, and said cross lower-wall portion is fixed to said recess-portion lower edge from an upper side.

4. The front structure of the vehicle of claim 3, wherein said cross member comprises a cross body portion which includes said cross rear-wall portion, said cross upper-wall portion, said cross lower-wall portion, a cross upper-flange portion extending upward from a front edge of said cross upper-wall portion, and a cross lower-flange portion extending downward from a front edge of said cross lower-wall portion and a cross front-wall portion which extends vertically between said cross upper-flange portion and said cross lower-flange portion and is fixed to said cross body portion from the forward side.

5. The front structure of the vehicle of claim 3, wherein said cross rear-wall portion is fixed to said recess-portion bottom edge by line welding, said cross upper-wall portion is fixed to said recess-portion upper edge by line welding, and said cross lower-wall portion is fixed to said recess-portion lower edge by line welding.

6. The front structure of the vehicle of claim 1, wherein the both-side portions of said cross member protrude outward, in the vehicle width direction, from said pair of right-and-left front side frames.

7. The front structure of the vehicle of claim 1, further comprising a pair of right-and-left impact absorbing members which are provided at respective front sides of said pair of right-and-left front side frames via said cross member and extend forward from said cross member.

8. The front structure of the vehicle of claim 7, wherein the both-side portions of said cross member protrude outward, in the vehicle width direction, from said pair of right-and-left impact absorbing members.

9. The front structure of the vehicle of claim 7, wherein said cross member has a cross section perpendicular to an extension direction thereof which is of a uniform shape over a width direction thereof and comprises a cross front-wall portion extending in a vertical direction and a cross body portion which is joined to said cross front-wall portion from a rearward side and forms said closed-cross section together with said cross front-wall portion, and said impact absorbing member is fixed to said cross front-wall portion.

10. The front structure of the vehicle of claim 4, wherein said pair of right-and-left front side frames are configured such that respective front end faces thereof are fixed to said cross upper-flange portions and said cross lower-flange portions from a rearward side.

11. The front structure of the vehicle of claim 1, wherein each of said pair of right-and-left front side frames has a side wall portion where said recess portion is formed, and a groove portion which is recessed in the vehicle width direction and extends rearward from said recess portion or a protrusion portion which protrudes in the vehicle width direction and extends rearward from said recess portion are formed at said side wall portion.

12. The front structure of the vehicle of claim 2, wherein the both-side portions of said cross member protrude outward, in the vehicle width direction, from said pair of right-and-left front side frames.

13. The front structure of the vehicle of claim 2, further comprising a pair of right-and-left impact absorbing members which are provided at respective front sides of said pair of right-and-left front side frames via said cross member and extend forward from said cross member.

14. The front structure of the vehicle of claim 2, wherein each of said pair of right-and-left front side frames has a side wall portion where said recess portion is formed, and a groove portion which is recessed in the vehicle width direction and extends rearward from said recess portion or a protrusion portion which protrudes in the vehicle width direction and extends rearward from said recess portion are formed at said side wall portion.

15. The front structure of the vehicle of claim 1, wherein said pair of right-and-left front side frames extend obliquely forward-and-outward, in the vehicle width direction, thereof.

16. The front structure of the vehicle of claim 6, wherein said pair of right-and-left front side frames extend obliquely forward-and-outward, in the vehicle width direction, thereof.

17. The front structure of the vehicle of claim 7, wherein said impact absorbing member extends in parallel to an axial direction of said front side frame.
